(19) United States
(12) Patent Application Publication
(10) Pub. No.: US 2022/0158165 A1
(43) Pub. Date: May 19, 2022

(54) METHOD FOR PRODUCING CATHODE ACTIVE MATERIAL, CATHODE ACTIVE MATERIAL, AND METHOD FOR PRODUCING LITHIUM ION BATTERY

(71) Applicant: TOYOTA JIDOSHA KABUSHIKI KAISHA, Toyota-shi (JP)

(72) Inventor: Issei SUGIYAMA, Susono-shi (JP)

(73) Assignee: TOYOTA JIDOSHA KABUSHIKI KAISHA, Toyota-shi (JP)

(21) Appl. No.: 17/495,932

(22) Filed: Oct. 7, 2021

(30) Foreign Application Priority Data
Nov. 13, 2020 (JP) 2020-189681

(51) Int. Cl. H01M 4/131; H01M 10/0525; H01M 4/485

(52) U.S. Cl. CPC H01M 4/131; H01M 2004/028; H01M 4/485; H01M 10/0525

(57) ABSTRACT

A main object of the present disclosure is to provide a cathode active material having excellent capacity properties. The present disclosure achieves the object by providing a method for producing a cathode active material including an O2-type structure, the method comprising: a preparing step of preparing a transition metal oxide containing Na and including a P2-type structure; and an ion exchanging step of exchanging a Na ion included in the transition metal oxide with a Li ion; wherein temperature for the ion exchanging is 350° C. or more and 600° C. or less.

### TECHNICAL FIELD

The present disclosure relates to a method for producing a cathode active material, a cathode active material, and a method for producing a lithium ion battery.

### BACKGROUND ART

With the miniaturization of personal computers, video cameras, mobile phones, etc., in the fields of information-related equipment and communication equipment, lithium secondary batteries have been put into practical use and widely used as power sources for these equipment because of their high energy density. On the other hand, in the field of automobiles, the development of battery electric vehicles is urgently needed due to environmental problems and resource problems, and lithium secondary batteries are being studied as a power source for these battery electric vehicles.

As a cathode active material in a battery, various oxides have been known. Conventionally, a layered compound including an O3-type structure has been used as the cathode active material. In the layered compound including the O3-type structure, a crystal structure may be changed in high potential condition such as 4.4 V or more. As a result, there has been a problem that the maintenance capacity rate is degraded when a charge and discharge cycle under the high potential condition is repeated.

From the above background, for example, as disclosed in Patent Literatures 1 and 2, a method known is to synthesize a layered cathode active material including an O2-type structure by exchanging Na ions of a Na doped precursor including a P2-type structure with Li ions. Also, Non-Patent Literature 1 describes that faulted stacking structure would not be formed when a layered cathode active material with the O2-type structure is synthesized by a general method.

### CITATION LIST

### Patent Literatures

Patent Literature 1: Japanese Patent Application Laid-Open (JP-A) No. 2014-186937
Patent Literature 2: JP-A No. 2010-92824

### Non-Patent Literature

Non-patent Literature 1: F. Tournadre, et al., J. Solid State Chem. 177 (2004) 2803-2809.

### SUMMARY OF DISCLOSURE

### Technical Problem

From a viewpoint of improving performance of a battery, a cathode active material with excellent capacity properties has been demanded. The present disclosure has been made in view of the above circumstances and a main object thereof is to provide a method for producing a cathode active material with excellent capacity properties.

### Solution to Problem

In order to solve the problem, the present disclosure provides a method for producing a cathode active material including an O2-type structure, the method comprising: a preparing step of preparing a transition metal oxide containing Na and including a P2-type structure; and an ion exchanging step of exchanging a Na ion included in the transition metal oxide with a Li ion; wherein temperature for the ion exchanging is 350° C. or more and 600° C. or less.

According to the present disclosure, the ion exchanging is conducted in the temperature range of 350° C. or more and 600° C. or less, and thus the cathode active material with excellent capacity properties may be obtained.

In the disclosure, the cathode active material may include a composition represented by LiₚMnₓNi_{y}Co_{z}Me_{(1-x-y-z)}O₂ provided that x, y, z satisfy 0≤x≤1, 0≤y≤1, 0≤z≤1, and 0<x+y+z≤1, p satisfies 0.5≤p≤1, and Me is at least one kind of Al, Fe, Mg, Ca, Ti, Cr, Cu, Zn, Nb, and Mo.

The present disclosure also provides a method for producing a lithium ion battery, the method comprising: a synthesizing step of obtaining a cathode active material by the above described method for producing the cathode active material; and a cathode layer forming step of forming a cathode layer using the cathode active material.

According to the present disclosure, the cathode active material produced by the above described method is used, and thus the lithium ion battery with excellent capacity properties may be obtained.

The present disclosure also provides a cathode active material comprising an O2-type structure, wherein the O2-type structure includes a turbostratic structure.

According to the present disclosure, the O2-type structure including a turbostratic structure allows a cathode active material to have excellent capacity properties.

### Advantageous Effects of Disclosure

The present disclosure exhibits an effect of providing a cathode active material with excellent capacity properties.

### BRIEF DESCRIPTION OF DRAWINGS

FIG. 1 is a flow chart illustrating an example of the method for producing the cathode active material in the present disclosure.

FIG. 2 is a diagram illustrating an example of the O2-type structure in the present disclosure.

FIG. 3 is a drawing for explaining a reciprocal lattice in the turbostratic structure.

FIG. 4 is a drawing for explaining the lithium ion battery in the present disclosure.

FIG. 5 is the result of an X-ray diffraction measurement for a cathode active material produced in Example 1.

FIG. 6 is the result of an electron beam diffraction measurement for a cathode active material produced in Example 1.

FIG. 7 is the result of an X-ray diffraction measurement for a cathode active material produced in Example 2.

FIG. 8 is the result of an electron beam diffraction measurement for a cathode active material produced in Example 2.

FIG. 9 is the result of an electron beam diffraction measurement for a cathode active material produced in Comparative Example 1.

FIG. 10 is the result of an X-ray diffraction measurement for a cathode active material produced in Comparative Example 2.

FIG. 11 is the result of a charge and discharge test for a coin cell produced in Example 1.

FIG. 12 is the result of a charge and discharge test for a coin cell produced in Comparative Example 1.

### DESCRIPTION OF EMBODIMENTS

The method for producing the cathode active material, the method for producing the lithium ion battery, and the cathode active material in the present disclosure will be hereinafter described in details.

A. Method for Producing Cathode Active Material

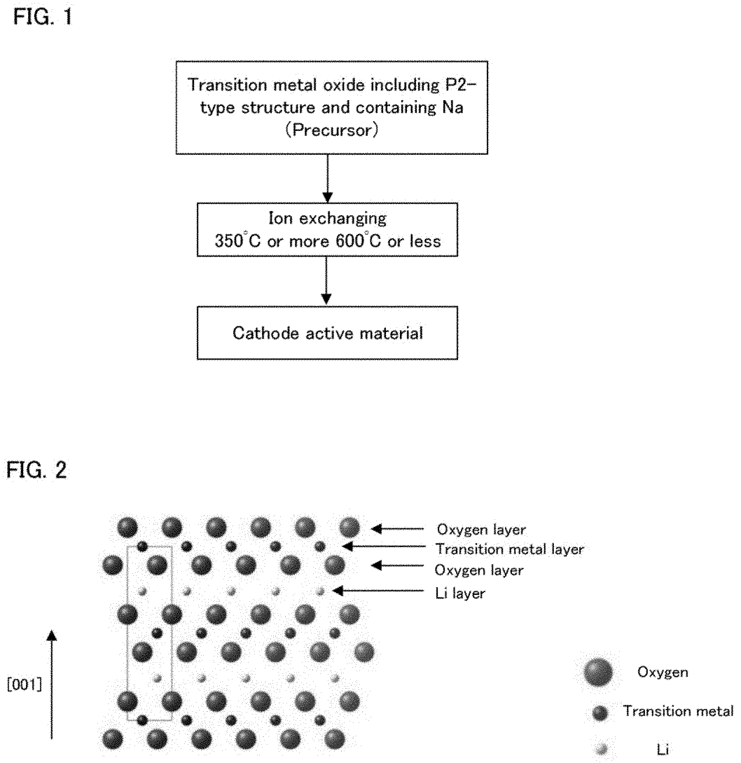

FIG. 1 is a flow-chart illustrating an example of the method for producing the cathode active material in the present disclosure. In FIG. 1, first, a transition metal oxide containing Na and including a P2-type structure is prepared as a precursor (preparing step). Next, Na ions included in the transition metal oxide are exchanged with Li ions to obtain a cathode active material (ion exchanging step). The present disclosure features that the temperature of the ion exchanging is 350° C. or more and 600° C. or less.

According to the present disclosure, the ion exchanging is conducted in the temperature range of 350° C. or more and 600° C. or less, and thus the cathode active material with excellent capacity properties may be obtained. The reason for excellent capacity properties is because a turbostratic structure is formed in the O2-type structure when the ion exchanging is conducted at the temperature higher than conventional temperature. Further, when the turbostratic structure is formed, disturbance in periodicity of interlayer direction (layering direction) occurs to weaken the interlayer bonding force. As a result, Li ions are allowed to move easily and the cathode active material may presumably have excellent capacity properties.

Lattice defects in the cathode active material may possibly be a factor of inhibiting intercalation and desorption of Li ions. For this reason, conventionally, the object of the synthesis of cathode active materials has been an ideal crystal structure not having lattice defects. Also, studies of lattice defects have been conducted. The aforementioned Non-Patent Literature 1 describes that faulted stacking structure (one kind of lattice defects) would not be introduced when a layered cathode active material (LiCoO₂) with the O2-type structure is synthesized by a general method.

The inventor of the present disclosure has focused on the point that the chemical bond inside an active material (interlayer bonding force of layered structure) is in “stronger” state when the integrity of the structure of the cathode active material is higher. Strong chemical bond may possibly inhibit the movement of Li ions moving through that bond (or between bonds). For this reason, the inventor of the present disclosure has studied on weakening the chemical bond inside an active material without inhibiting intercalation and desorption reaction of Li ions in the active material.

Meanwhile, in conventional process of synthesizing the cathode active material with the O2-type structure, it has been necessary to form the O2-type structure which is a metastable structure, at the same time of suppressing the formation of O3-type structure which is a stable structure. For this reason, heating temperature during ion exchanging has been set as lowest as possible. In specific, the O2-type structure is a metastable structure, and thus the direct synthesis thereof is difficult. Then, conventionally, in order to obtain the O2-type structure, a precursor containing sodium with a P2-type structure has been synthesized and the ion exchange of Na ions with Li ions has been conducted. On this occasion, the heating temperature during the ion exchange has been set as lowest as possible because the O3-type structure which is a stable structure is formed when the heating temperature is too high. In specific, the temperature is fixed at 280° C. in the aforementioned Patent Literatures 1 and 2. This temperature has been set as a temperature sufficient to dissolve a mixture of LiNO₃ and LiCl of which melting point is approximately 240° C., which is used for the ion exchange.

In contrast, the inventor of the present disclosure has studied about ion exchanging temperature in details based on the viewpoint of weakening the chemical bond inside the active material, and found out that there is a temperature region where a turbostratic structure is formed inside the O2-type structure, which is between a temperature region where the O2-type structure is formed and a temperature region where the O3-type structure is formed. In specific, the inventor has obtained the knowledge that the turbostratic structure is formed inside the O2-type structure in the temperature range of 350° C. or more and 600° C. or less. Since the turbostratic structure is a disorder of layering, it was presumed that the capacity properties would be degraded based on the conventional knowledge, but the inventor has found out that the improvement of the capacity properties was achieved on contrary. The reason therefor is presumably because the turbostratic structure moderately broke the O2-type structure.

The method for producing the cathode active material in the present disclosure will be hereinafter described in details.

1. Preparing Step

The preparing step in the present disclosure is a step of preparing a transition metal oxide containing Na and including a P2-type structure. The P2-type structure belongs to a space group P6₃/mmc, includes 2 kinds of oxide layers of which positions of oxides are different in a unit lattice, and has a crystal structure in which sodium ions occupy the prismatic site.

There are no particular limitations on the method for preparing the transition metal oxide and it can be produced by known methods. For example, it can be produced in following manners. First, a Mn source, a Ni source, and a Co source (one or two of the elements may be omitted if necessary) are mixed in a ratio so as to obtain a desired composition, and precipitated using a base. Then, a Na source is added to the precipitated powder in a ratio so as to obtain the desired composition and burned. On this occasion, an M source such as Al, Fe, Mg, Ca, Ti, Cr, Cu, Zn, Nb, and Mo may be mixed to obtain the desired composition. Also, preliminary burning may be conducted before burning. Thereby, a transition metal oxide that is a Na doped precursor can be obtained.

Here, examples of the Mn source, the Ni source, and the Co source may include a nitrate, a sulfate, hydroxide salt, and a carbonate including these metal elements. These may be a hydrate. Examples of the base used for precipitation may include a sodium carbonate and a sodium hydroxide. These may be used as an aqueous solution. Further, an ammonium aqueous solution may be added to adjust basicity. Examples of the Na source may include a sodium carbonate, a sodium oxide, a sodium nitrate, and a sodium hydroxide. The burning temperature is, for example, 700° C. or more and 1100° C. or less. If the burning temperature is too low, there is a possibility that sufficient doping of Na may not be conducted, and if the burning temperature is too high, there is a possibility that the O3-type structure may be formed instead of the P2-type structure. The burning temperature may be 800° C. or more and 1000° C. or less. Also, when the preliminary burning is conducted, the temperature for the preliminary burning is preferably lower than that of the main burning. The temperature for the preliminary burning is, for example, around 600° C.

It is preferable that the transition metal oxide has the P2-type structure as a main phase. “Having the P2-type structure as a main phase” means that one of the peaks belonging to the P2-type structure corresponds to the highest diffraction intensity among the peaks observed in an X-ray diffraction (XRD) measurement. The transition metal oxide may be a single phase material of the P2-type structure. Also, the transition metal oxide may not have the O3-type structure. “Not having the O3-type structure” means that the peaks belonging to the O3-type structure are not observed in an XRD measurement.

The composition of the transition metal oxide is not particularly limited, and examples thereof may include a composition represented by Na_{q}MnₓNi_{y}Co_{z}Me_{(1-x-y-z)}O₂ provided that x, y, z satisfy 0≤x≤1, 0≤y≤1, 0≤z≤1, and 0<x+y+z≤1, q satisfies 0.5≤q≤1, and Me is at least one kind of Al, Fe, Mg, Ca, Ti, Cr, Cu, Zn, Nb, and Mo. The “x” may be 0 and may be larger than 0. The “y” may be 0 and may be larger than 0. The “z” may be 0 and may be larger than 0. Also, “x+y+z” may be 1 and may be smaller than 1. The composition of the transition metal oxide may be confirmed by, for example, ICP.

2. Ion Exchanging Step

The ion exchanging step in the present disclosure is a step of exchanging a Na ion included in the transition metal oxide with a Li ion. In the ion exchanging step, at least a part of Na ions included in the transition metal oxide is substituted with Li ions utilizing the ion exchanging reaction of the transition metal oxide and the Li ion source. Also, in the present disclosure, the temperature for the ion exchanging is 350° C. or more and 600° C. or less.

In the present disclosure, the heating temperature is 350° C. or more, and thus the turbostratic structure can be formed in the O2-type structure. This is because the desorption of Na⁺ and the intercalation of Li⁺ during the ion exchanging rapidly progress when the heating temperature is 350° C. or more. In particular, during the movement of Na⁺ of which ionic radius is large, the bond between two oxygen layers which sandwich Na⁺/Li⁺ layer is weakened. If the movement of a lot of Na+ simultaneously occurs, when the oxygen layers are recombined, the recombination would presumably occur at the point shifted. As a result, for example, upper oxygen layer rotates with respect to lower oxygen layer to presumably form the turbostratic structure. The heating temperature may be 400° C. or more.

Meanwhile, in the present disclosure, the heating temperature is 600° C. or less, and thus the formation of the O3-type structure may be suppressed while forming the turbostratic structure in the O2-type structure. The heating temperature may be 550° C. or less.

Examples of the Li ion source may include a lithium salt such as lithium chloride, lithium bromide, lithium iodide, and lithium nitrate. Two kinds or more of the lithium salt may be used as the Li ion source. In particular, when a mixture of lithium chloride and lithium nitrate is used, the melting point of the mixture can be lowered. Also, the proportion of the lithium chloride with respect to the total of lithium chloride and lithium nitrate is, for example, 70 mol % or more and 95 mol % or less, and may be 80 mol % or more and 90 mol % or less.

There are no particular limitations on the amount of use of the Li ion source. The Li amount included in the Li ion source with respect to the Na amount included in the transition metal oxide is, for example, 1.1 times or more, may be 3 times or more, and may be 5 times or more in a molar ratio. Meanwhile, the Li amount is, for example, 15 times or less and may be 12 times or less in a molar ratio.

The heating time is not particularly limited if it is enough time to form the O2-type structure including the turbostratic structure; for example, it is 30 minutes or more and 10 hours or less, and may be 30 minutes or more and 2 hours or less.

In the ion exchanging step, at least a part of Na ions included in the transition metal oxide is substituted with Li ions. Above all, it is preferable that 99 atm % or more of Na included in the transition metal oxide is substituted with Li. The reason for the amount 99 atm % or more is because the measurement limitation (1% or less) of measurement devices such as ICP is taken into account. Thus, the status of 99 atm % or more of sodium being substituted with lithium means the status of no Na detected when the composition after the ion exchanging is measured by a device such as ICP.

3. Cathode Active Material

The cathode active material in the present disclosure includes an O2-type structure. The O2-type structure is a crystal structure wherein Li occupies the octahedral site in the oxide, and 2 kinds of oxide layers (layers including oxygen and transition metal) of which positions of oxygen are different are present in a unit lattice. The diagram of the O2-type structure is shown in FIG. 2. In the O2-type structure shown in FIG. 2, Li layer, transition metal layer, and oxygen layer are stacked along with c-axis direction (direction of [001]) of unit lattice.

Whether the cathode active material includes the O2-type structure can be confirmed by an XRD measurement. The cathode active material in the present disclosure preferably has the O2-type structure as a main phase. “Having the O2-type structure as a main phase” means that one of the peaks belonging to the O2-type structure corresponds to the highest diffraction intensity among the peaks observed in an X-ray diffraction (XRD) measurement. The cathode active material may be a single phase material of O2-type structure.

Also, the O2-type structure in the present disclosure usually includes a turbostratic structure. The “turbostratic structure” refers to a structure wherein the positions of the oxygen layers stacked so as to sandwich Li are displaced from the position of the O2-type structure by rotating around the stacking direction (c-axis direction, [001]), and such displacement randomly occurs. Incidentally, faulted stacking structure is a lattice defect formed due to disorder of the stacking of atom surfaces of crystal, and it is different from “turbostratic structure”.

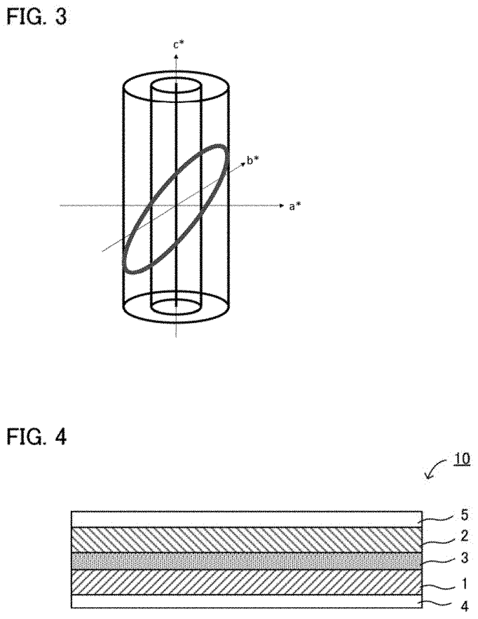

Whether the cathode active material in the present disclosure includes the turbostratic structure can be confirmed by an electron beam diffraction measurement. In specific, in an electron beam diffraction image obtained from an area including whole single particle in [a b c] directions (here, c is an integer of c>0, both a and b are integers, a≥0, b≥0, and either a or b is not 0), if diffraction points or lines which cannot belong to a single crystallite appears, and those diffraction points or lines are arranged in an oval shape, the inclusion of the turbostratic structure in the cathode active material can be confirmed. Incidentally, the oval shape refers to a round shape which is not perfect circle; specifically, the ratio of the length of the long diameter with respect to the length of the short diameter is larger than 1. This is because the reverse lattice of the turbostratic structure cut in the surface not vertical or parallel to c-axis is the oval shape as shown in FIG. 3. The ratio of the length of the long diameter with respect to the length of the short diameter may be, for example, 1.2 or more.

The cathode active material in the present disclosure may not have an O3-type structure. The O3-type structure refers to a structure wherein Li occupies octahedral site in the oxide, and 3 kinds of oxide layers of which positions of oxide are different are present in a unit lattice. “Not having the O3-type structure” means that the peaks belonging to the O3-type structure are not observed in an XRD measurement. Meanwhile, the cathode active material may have the O3-type structure. When I₀₀₂ designates a peak intensity derived from 002 surface of the O2-type structure and I₀₀₃ designates a peak intensity derived from 003 surface of the O3-type structure in an XRD measurement using a CuKα-ray, I₀₀₃/I₀₀₂ is, for example, 0.3 or less, and may be 0.1 or less.

The cathode active material in the present disclosure may or may not have a P2-type structure derived from the transition metal oxide. When I₀₀₂ designates a peak intensity derived from 002 surface of the O2-type structure and I_{002′} designates a peak intensity derived from 002 surface of the P2-type structure in an XRD measurement using a CuKα-ray, I_{002′}/I₀₀₂ is, for example, 0.3 or less, and may be 0.1 or less.

The composition of the cathode active material is not particularly limited, and examples thereof may include a composition represented by LiₚMnₓNi_{y}Co_{z}Me_{(1-x-y-z)}O₂ provided that x, y, z satisfy 0≤x≤1, 0≤y≤1, 0≤z≤1, and 0<x+y+z≤1, p satisfies 0.5≤p≤1, and Me is at least one kind of Al, Fe, Mg, Ca, Ti, Cr, Cu, Zn, Nb, and Mo. The “x” may be 0 and may be larger than 0. The “y” may be 0 and may be larger than 0. The “z” may be 0 and may be larger than 0. Also, “x+y+z” may be 1 and may be smaller than 1. The composition of the cathode active material can be confirmed by, for example, ICP.

Examples of the shape of the cathode active material may include a granular shape. The average particle size (D₅₀) of the cathode active material is, for example, 1 nm or more, and may be 10 nm or more. The average particle size (D₅₀) of the cathode active material is, for example, 100 μm or less, and may be 30 μm or less.

B. Method for Producing Lithium Ion Battery

A method for producing a lithium ion battery in the present disclosure comprises a synthesizing step of obtaining a cathode active material by the method for producing the cathode active material described above, and a cathode layer forming step of forming a cathode layer using the cathode active material.

According to the present disclosure, the cathode active material produced by the above described method is used, and thus the lithium ion battery with excellent capacity properties may be obtained.

1. Synthesizing Step

The synthesizing step in the present disclosure is a step of obtaining a cathode active material by the method for producing the cathode active material described above. The details of the synthesizing step in the present disclosure are in the same contents as those described in “A. Method for producing cathode active material” above; thus, the descriptions herein are omitted.

2. Cathode Layer Forming Step

The cathode layer forming step in the present disclosure is a step of forming a cathode layer using the aforementioned cathode active material. There are no particular limitations on the method for forming the cathode layer, and known methods can be used. Examples of the method for forming the cathode layer may include a method in which materials for forming the cathode layer are dispersed in a dispersion medium to produce slurry, and the slurry is pasted and dried to form a cathode layer. Examples of the method may also include a method in which materials for forming the cathode layer are mixed in dry, and pressed to form a cathode layer.

The cathode layer in the present disclosure is a layer containing at least a cathode active material. The details of the cathode active material are as described above. The cathode layer may further contain at least one of an electrolyte, a conductive material, and a binder. The electrolyte may be an electrolyte solution and may be a solid electrolyte. Examples of the electrolyte solution may include a non-aqueous electrolyte solution containing a supporting electrolyte and non-aqueous solvent. Examples of the supporting electrolyte may include LiPF₆ and LiBF₄. Examples of the non-aqueous solvent may include ethylene carbonate (EC), propylene carbonate (PC), mono-fluoroethylene carbonate (FEC), dimethyl carbonate (DMC), ethyl methyl carbonate (EMC), and methyl-2,2,2-tri-fluoroethyl carbonate (MTFEC).

Examples of the solid electrolyte may include an inorganic solid electrolyte such as an oxide solid electrolyte and a sulfide solid electrolyte. Examples of the oxide solid electrolyte may include lanthanum zirconate lithium, LiPON, Li₁₊ₓAlₓGe₂₋ₓ(PO₄)₃, Li—SiO-based glass, and Li—Al—S—O-based glass. Examples of the sulfide solid electrolyte may include Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, and Li₂S—P₂S₅—GeS₂.

Examples of the conductive material may include a carbon material such as acetylene black, Ketjen black, VGCF (vapor-grown carbon fiber), and graphite. Examples of the binder may include a fluorine-based binder such as polyvinylidene fluoride (PVDF), polytetra fluoroethylene (PTFE), and a rubber-based binder such as styrene butadiene rubber (SBR).

3. Other Steps

The method for producing the lithium ion battery in the present disclosure may include an anode layer forming step and an electrolyte layer forming step, other than the synthesizing step and the cathode layer forming step.

There are no particular limitations on the method for forming the anode layer, and known methods can be used. Examples of the method for forming the anode layer may include a method in which materials for forming the anode layer are dispersed in a dispersion medium to produce slurry, and the slurry is pasted and dried to form an anode layer. The anode layer is a layer containing at least an anode active material. Examples of the anode active material may include a carbon active material such as a metal active material containing a metal element such as Li and Si, and graphite. The anode layer may further contain at least one of an electrolyte, a conductive material, and a binder. These materials are in the same contents as those in the cathode layer.

There are no particular limitations on the method for forming the electrolyte layer. Examples of the method for forming a solid electrolyte layer containing a solid electrolyte may include a method in which materials for forming the solid electrolyte layer are dispersed in a dispersion medium to produce slurry, and the slurry is pasted and dried to form the solid electrolyte layer. The solid electrolyte layer is a layer containing at least a solid electrolyte. The solid electrolyte layer may further contain a binder. These materials are in the same contents as those in the cathode layer.

4. Lithium Ion Battery

As shown in FIG. 4, lithium ion battery 10 comprises cathode layer 1, anode layer 2, and electrolyte layer 3 arranged between the cathode layer 1 and the anode layer 2. The electrolyte layer 3 may be a layer containing a liquid electrolyte, and may be a layer containing a solid electrolyte (particularly an inorganic solid electrolyte). Incidentally, the former corresponds to a liquid battery, and the latter corresponds to an all solid state battery. Also, the lithium ion battery 10 usually comprises cathode current collector 4 on the surface 3 of the cathode layer 1 which is opposite to the electrolyte layer, and comprises anode current collector 5 on the surface of the anode layer 2 which is opposite to the electrolyte layer 3.

Also, the lithium ion battery may be a primary battery and may be a secondary battery, but preferably a secondary battery. The reason therefor is to be repeatedly charged and discharged and useful as a car-mounted battery for example. Also, examples of the shape of the lithium ion battery may include a coin shape, a laminate shape, a cylindrical shape and a square shape.

C. Cathode Active Material

The cathode active material in the present disclosure is a cathode active material comprising an O2-type structure, wherein the O2-type structure includes a turbostratic structure.

According to the present disclosure, the O2-type structure includes the turbostratic structure, and thus the cathode active material may have excellent capacity properties. The details of the cathode active material in the present disclosure are in the same contents as those described in “A. Method for producing cathode active material” above; thus, the descriptions herein are omitted. Also, the cathode active material in the present disclosure is preferably used in a lithium ion battery. The present disclosure can also provide a lithium ion battery comprising a cathode layer containing the above described cathode active material.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

Mn(NO₃)₂.6H₂O, Ni(NO₃)₂.6H₂O and Co(NO₃)₂.6H₂O were used as raw materials, and those were dissolved in pure water so that the molar ratio of Mn, Ni and Co became 5:2:3. Further, Na₂CO₃ solution of concentration 12 weight % was produced and these two solutions were simultaneously titrated to a beaker. On this occasion, the titration speed was controlled so that pH became 7.0 or more and less than 7.1. After completion of the titration, the mixed solution was stirred for 24 hours in the condition of 50° C. and 300 rpm. The obtained reaction product was washed with pure water, and deposited powder was separated by centrifugal separation. The obtained powder was dried in the condition of 120° C. and 48 hours, and then crushed using an agate mortar. Na₂CO₃ was added to the obtained powder so that the composition ratio became Na_{0.7}Mn_{0.5}Ni_{0.2}Co_{0.3}O₂, and mixed. The mixed powder was pressed with the load of 2 ton by a cold isostatic pressing method to produce pellet. The preliminary burning was conducted to the obtained pellet in the condition of 600° C. and 6 hours in the air, and then burning was conducted in the condition of 900° C. and 24 hours to synthesize a Na-doped precursor (which was a transition metal oxide containing Na and including P2-type structure).

LiNO₃ and LiCl were mixed in the molar ratio of 88:12, the Na-doped precursor and LiNo₃.LiCl mixture powder were mixed, and the ion exchanging was conducted in the air in the condition of 350° C. and 1 hour. After the ion exchanging, water was added to dissolve salt, and further washed under water to obtain a cathode active material.

This cathode active material (powder after ball milling treatment) of 85 g was added to 125 mL of solvent n-methyl pyrrolidone solution in which 5 g of polyvinylidene fluoride (PVDF) as a binder was dissolved, and 10 g of carbon black as a conductive material was further added thereto. After that, the mixture was kneaded so that uniformly mixed to produce paste. This paste was pasted on one surface of an Al current collector having thickness of 15 μm in the weight amount of 6 mg/cm² and dried to obtain an electrode. After that, this electrode was pressed to adjust the thickness of the paste to 45 μm and the density of the paste to 2.4 g/cm³. Lastly, this electrode was cut out into ϕ 16 mm to obtain a cathode. Meanwhile, a Li foil was cut out into ϕ 19 mm to obtain an anode.

A CR2032-type coin cell was produced using the obtained cathode and anode. Incidentally, as a separator, a porous separator made of PP was used, and as an electrolyte, mixture of EC (ethylene carbonate) and DMC (dimethyl carbonate) in the volume ratio of 3:7 dissolved in lithium hexafluorophosphate (LiPF₆) as supporting electrolyte in the concentration of 1 mol/L was used.

### Example 2

A cathode active material and a coin cell were obtained in the same manner as in Example 1 except that the condition of the ion exchanging was changed to 600° C. and 5 minutes in the air.

### Comparative Example 1

A cathode active material and a coin cell were obtained in the same manner as in Example 1 except that the condition of the ion exchanging was changed to 280° C. and 1 hour in the air.

### Comparative Example 2

A cathode active material and a coin cell were obtained in the same manner as in Example 1 except that the condition of the ion exchanging was changed to 650° C. and 5 minutes in the air.

<X-Ray Diffraction Measurement and Electron Beam Diffraction Measurement>

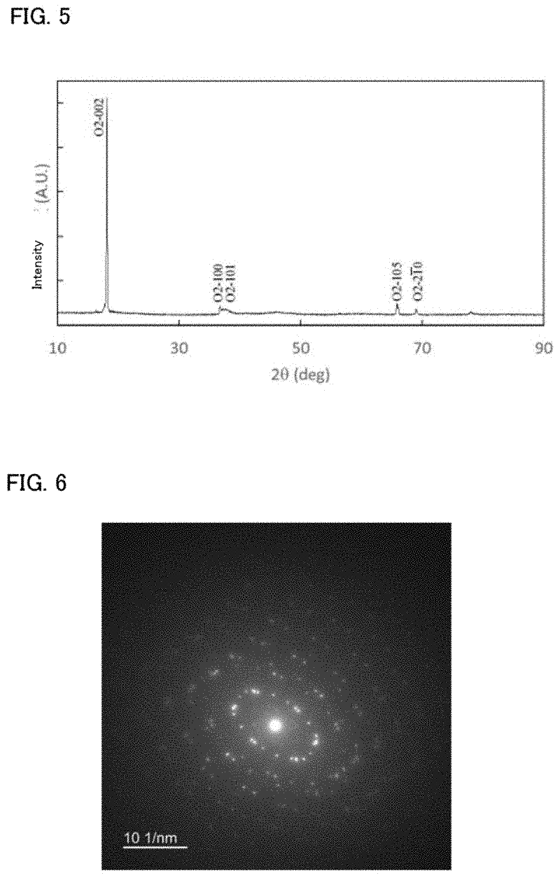

An X-ray diffraction measurement was conducted to the cathode active material produced in Example 1. As a result, as shown in FIG. 5, it was confirmed that the O2-type structure was obtained in a single phase. Also, an electron beam diffraction measurement was conducted to the cathode active material produced in Example 1. As a result, as shown in FIG. 6, it was confirmed that the diffraction spots were arranged in an oval shape, and thus the cathode active material had the turbostratic structure.

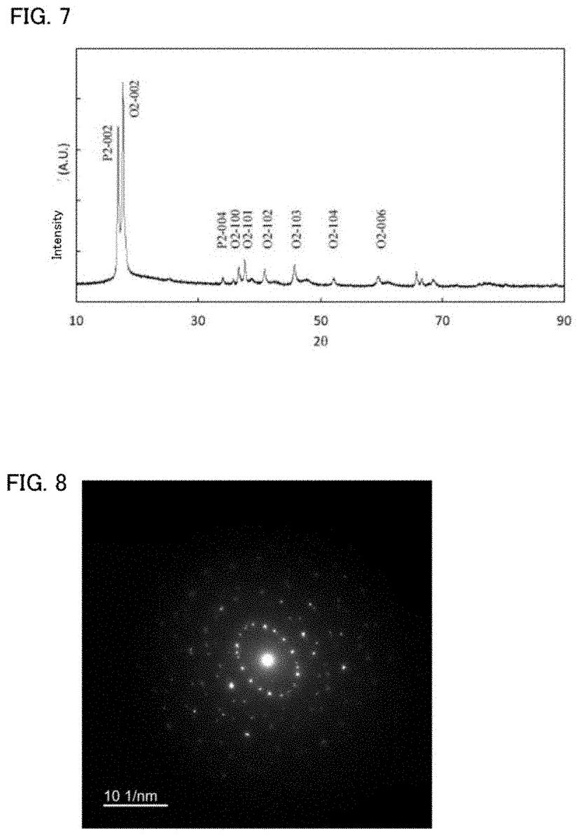

An X-ray diffraction measurement was conducted to the cathode active material produced in Example 2. As a result, as shown in FIG. 7, it was confirmed that the O2-type structure was obtained although the P2-structure before the ion exchanging was present as impurities. Also, an electron beam diffraction measurement was conducted to the cathode active material produced in Example 2. As a result, as shown in FIG. 8, it was confirmed that the diffraction spots were arranged in an oval shape, and thus the cathode active material had the turbostratic structure.

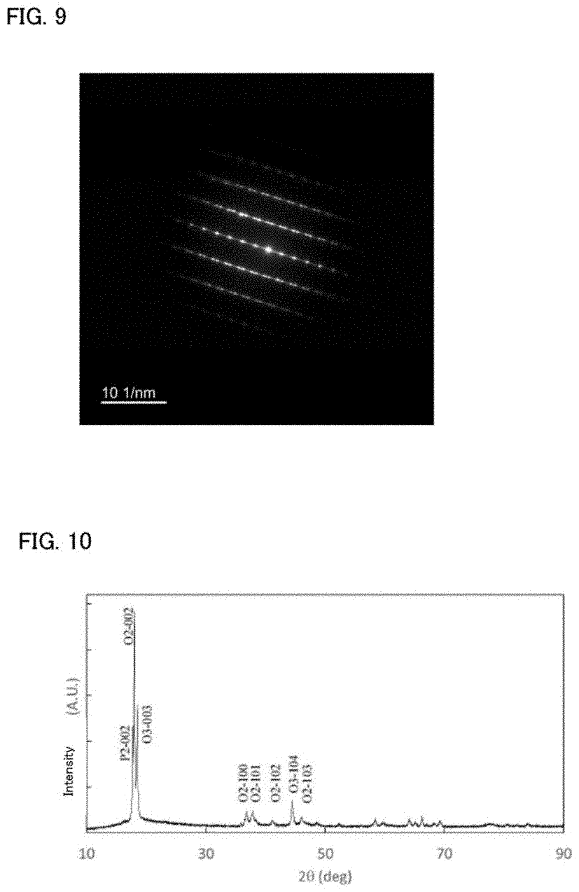

An electron beam diffraction measurement was conducted to the cathode active material produced in comparative Example 1. As a result, as shown in FIG. 9, it was confirmed that the diffraction spots were not arranged in an oval shape, and thus the cathode active material did not have the turbostratic structure. Also, an X-ray diffraction measurement was conducted to the cathode active material produced in Comparative Example 2. As a result, as shown in FIG. 10, it was confirmed that the cathode active material included the O3-type structure.

<Charge and Discharge Test>

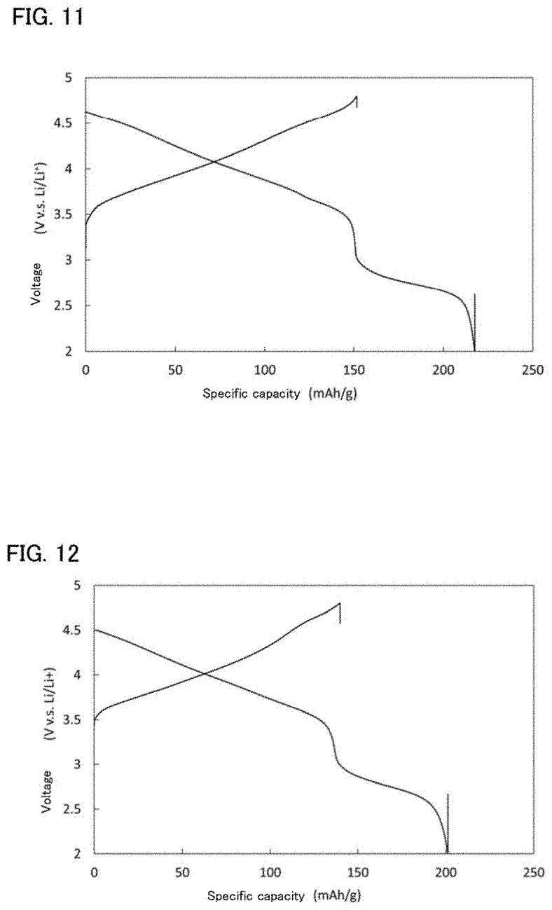

Charge and discharge tests were conducted to the coin cells produced in Examples 1, 2 and Comparative Examples 1 and 2. In specific, the cells were charged at 0.1 C until 4.8 V, and then discharged at 0.1 C until 2.0 V. The result of Example 1 is shown in FIG. 11, and the result of Comparative Example 1 is shown in FIG. 12. Also, the results of initial discharge capacity in Examples 1, 2, and Comparative Examples 1 and 2 are shown in Table 1.

TABLE 1

| | |
|---|---|
| Ion exchanging | Initial discharge |
| conditions | capacity [mAh/g] |

| | | | |
|---|---|---|---|
| Example 1 | 350° C. | 1 hour | 217.5 |
| Example 2 | 600° C. | 5 minutes | 213.8 |
| Comparative | 280° C. | 1 hour | 200.6 |
| Example 1 | | | |
| Comparative | 650° C. | 5 minutes | 182.5 |
| Example 2 | | | |

As shown in Table 1, the initial discharge capacity of Example 1 and Example 2 was larger than that of Comparative Example 1 and Comparative Example 2. The reason therefor is presumably because the cathode active materials produced in Example 1 and Example 2 have the O2-type structure including the turbostratic structure.

### REFERENCE SIGNS LIST

1 cathode layer
2 anode layer
3 electrolyte layer
4 cathode current collector
5 anode current collector
10 lithium ion battery

What is claimed is:

1. A method for producing a cathode active material including an O2-type structure, the method comprising:
a preparing step of preparing a transition metal oxide containing Na and including a P2-type structure; and
an ion exchanging step of exchanging a Na ion included in the transition metal oxide with a Li ion; wherein
temperature for the ion exchanging is 350° C. or more and 600° C. or less.

2. The method for producing the cathode active material according to claim 1, wherein the cathode active material includes a composition represented by LiₚMnₓNi_{y}Co_{z}Me_{(1-x-y-z)}O₂ provided that x, y, z satisfy 0≤x≤1, 0≤y≤1, 0≤z≤1, and 0<x+y+z≤1, p satisfies 0.5≤p≤1, and Me is at least one kind of Al, Fe, Mg, Ca, Ti, Cr, Cu, Zn, Nb, and Mo.

3. A method for producing a lithium ion battery, the method comprising:
a synthesizing step of obtaining a cathode active material by the method for producing the cathode active material according to claim 1; and
a cathode layer forming step of forming a cathode layer using the cathode active material.

4. A cathode active material comprising an O2-type structure, wherein
the O2-type structure includes a turbostratic structure.
